(19) United States
(12) Patent Application Publication
(10) Pub. No.: US 2009/0013093 A1
(43) Pub. Date: Jan. 8, 2009

(54) SELF-CONTROLLED FUNCTIONAL MODULE, AND CONTROL METHOD THEREFOR AND SYSTEM USING THE SAME

(75) Inventors: Wonjong KIM, Daejon (KR); Seung-Chul Kim, Daejon (KR); Han-Jin Cho, Daejon (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejon (KR)

(21) Appl. No.: 12/111,522

(22) Filed: Apr. 29, 2008

(30) Foreign Application Priority Data
Jul. 6, 2007 (KR) 10-2007-0068345

(51) Int. Cl. G06F 3/00

(52) U.S. Cl. 710/8

(57) ABSTRACT

Provided are a self-controlled functional module, and a control method therefor and a system using the same. The functional module, includes: a data input unit for receiving data; a function process unit for performing a specific function based on input data transmitted through the data input unit; a data output unit for outputting a result processed by the function process unit; and an operation control unit for receiving state information individually from the data input unit and the data output unit and controlling operation start of the function process unit based on state information of the data input unit and the data output unit.

### CROSS-REFERENCE TO RELATED APPLICATIONS

The present invention claims priority of Korean Patent Application No. 10-2007-0068345, filed on Jul. 6, 2007, which is incorporated herein by reference.

### BACKGROUND OF THE INVENTION

1. Field of the Invention

The present invention relates to a self-controlled functional module, and a control method therefor and a system using the same; and, more particularly, to a self-controlled functional module which can minimize a role of a control processor for controlling operation of each functional module and realize a system without the control processor since each functional module performs self-control in a system using a plurality of functional modules which independently perform functions, and a control method therefor and a system using the same.

This work was supported by the IT R&D program for MIC/IITA [2005-S-078-02, “Mobile Multmedia SoC platform with high performance 3D Graphic Engine”].

2. Description of Related Art

Generally, a hardware system is formed by systematically combining a plurality of functional modules which independently perform functions. The hardware system uses a control processor or a control device similar to the control processor in order to control an operation of each functional module. The control processor and the control device similar to the control processor are called a control processor.

The control processor controls entire operations by grasping a state of each functional module. Since the control processor cannot simultaneously grasp and process the operation state of all functional modules operating in parallel, the control processor sequentially grasp the operation state of each functional module and controls the operation of the functional module according to the operation state of each functional module. Herein, a functional module completing a function process before the functional module is controlled by the control processor is in a waiting state until the control processor indicates to start a next process. When the waiting states increase, entire system efficiency degrades. When the operation of each functional module has minimal waiting states, the efficiency of the system can be maximized.

### SUMMARY OF THE INVENTION

An embodiment of the present invention is directed to providing a self-controlled functional module which can minimize a process waiting time of each functional module and improve efficiency of the system by checking a processing state of input data, an input parameter and output data and performing self-control by each functional module in a system using a plurality of functional modules which performs each independent function, a control method therefor and a system using the same.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a functional module used in a system including a plurality of functional modules for performing independent functions, including: a data input unit for receiving data; a function process unit for performing a specific function based on input data transmitted through the data input unit; a data output unit for outputting a result processed by the function process unit; and an operation control unit for receiving state information individually from the data input unit and the data output unit and controlling operation start of the function process unit based on state information of the data input unit and the data output unit.

Preferably, the functional module, further includes: a parameter input unit for receiving a parameter for determining an operation mode of the function process unit, where the operation control unit controls operation start of the function process unit based on state information of the data input unit, the data output unit and the parameter input unit.

In accordance with another aspect of the present invention, there is provided a a functional module used in a system including a plurality of functional modules for performing independent functions, including: a first data input unit for receiving data; a first function process unit for performing a specific function based on input data transmitted through the first data input unit; a first data output unit for outputting a result processed by the first function process unit; and an operation control unit for receiving state information from the first data input unit, receiving state information of a second data input unit and information of a second function process unit included in another cooperating functional module from another cooperating functional module, and controlling operation start of the first function process unit based on the state information of the first and second data input unit.

Preferably, the operation control unit outputs a control signal which indicates operation start of the first function process unit in cases that the state information of the first data input unit shows presence of inputted data and that the state information of the second data input unit shows presence of space for receiving data.

In accordance with another aspect of the present invention, there is provided a a method for controlling operation in a functional module used in a system including a plurality of functional modules for performing independent functions, including the steps of: receiving input data state information showing whether there are input data and output data state information showing whether processed data can be stored; and outputting a control signal which indicates operation start of a function process unit for performing an independent function in cases that the input data state information shows presence of inputted data and that the output data state information shows presence of the storing space.

Preferably, the method further includes the step of: receiving a parameter for determining an operation mode of the function process unit, where in the step of outputting the control signal, the control signal indicating the operation start of the function process unit performing the independent function in cases that the input data state information shows presence of inputted data and that the output data state information shows presence of storing space and presence of the inputted parameter is outputted.

In accordance with another aspect of the present invention, there is provided a system including a plurality of functional modules for performing independent functions, including: a first-in first-out (FIFO) buffering unit for temporarily buffering data transmitted between the functional modules by being located between the cooperating functional modules, where each of the functional modules includes: a data input unit for receiving data; a function process unit for performing a specific function based on input data transmitted through the data input unit; a data output unit for outputting a result processed by the function process unit; and an operation control unit for receiving state information individually from the data input unit and the data output unit and controlling operation start of the function process unit based on state information of the data input unit and the data output unit.

In accordance with another aspect of the present invention, there is provided a system including a plurality of functional modules for performing independent functions, each functional module including: a data input unit for receiving data; a function process unit for performing a specific function based on input data transmitted through the data input unit; a data output unit for outputting a result processed by the function process unit; and an operation control unit for receiving state information individually from the data input unit and the data output unit and controlling operation start of the function process unit based on the state information of the data input unit and the data output unit, where the data output unit of a first functional module and the data input unit of a second functional module cooperatively transmit and receive a control signal and data are directly transmitted from the data output unit of the first functional module to the data input unit of the second functional module.

### BRIEF DESCRIPTION OF THE DRAWINGS

FIG. 1 is a block diagram showing a functional module having a self-controlled function in accordance with an embodiment of the present invention.

FIG. 2 is a block diagram describing a functional module in accordance with another embodiment of the present invention.

FIG. 3 is a block diagram showing a system using a plurality of functional modules in accordance with an embodiment of the present invention.

FIG. 4 is a block diagram showing a system using a plurality of functional modules in accordance with another embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

FIG. 1 is a block diagram showing a functional module having a self-controlled function in accordance with an embodiment of the present invention.

Referring to FIG. 1, the functional module includes a data input unit 100 for receiving data, a function process unit 120 for processing a required function using received data inputted in the data input unit 100, a data output unit 130 for outputting the data processed by the function process unit 120, and an operation control unit 110 for grasping states of the data input unit 100 and the data output unit 130 and controlling the operation of the function process unit 120.

The data input unit 100 may include a general memory and a memory control logic. When data are inputted in the memory, the data input unit 100 transmits state information of the memory to the operation control unit 110.

The data output unit 130 may include a general memory and a memory control logic. The data output unit 130 transmits the data, which are stored by transmitting and receiving a control signal with the data input unit of another cooperating functional module, to the data input unit of another functional module. The data output unit 130 transmits the state information of the memory to the operation control unit 110.

The function process unit 120 performs a necessary function, which is controled by the operation control unit 110. The function process unit 120 may include a processor and a read only memory (ROM) or a random access memory (RAM) for storing a program.

The operation control unit 110 receives the state information of the data input unit 100 and the state information of the data output unit 130, and controls whether to operate the function process unit 120. In order words, the operation control unit 110 transmits a control signal for starting operation of the function process unit 120 to the function process unit 120 when the data to be processed are stored in the data input unit 100 and the state of the data output unit 130 is not in memory full state. However, when the data to be processed are not stored in the data input unit 100, or when the state of the data output unit 130 is in memory full state, the operation control unit 110 does not start operation of the function process unit 120.

Meanwhile, when the data output unit does not include a general memory and a process result of the function process unit 120 is transmitted to the data input unit of another cooperating functional module, the operation control unit 110 can receive state information of the data input unit and the function process unit of another functional module from the operation control unit of another functional module. As described above, the operation control unit transmits a control signal for starting the operation of the function process unit to the function process unit when the process result of the function process unit can be stored in the data input unit of another functional module.

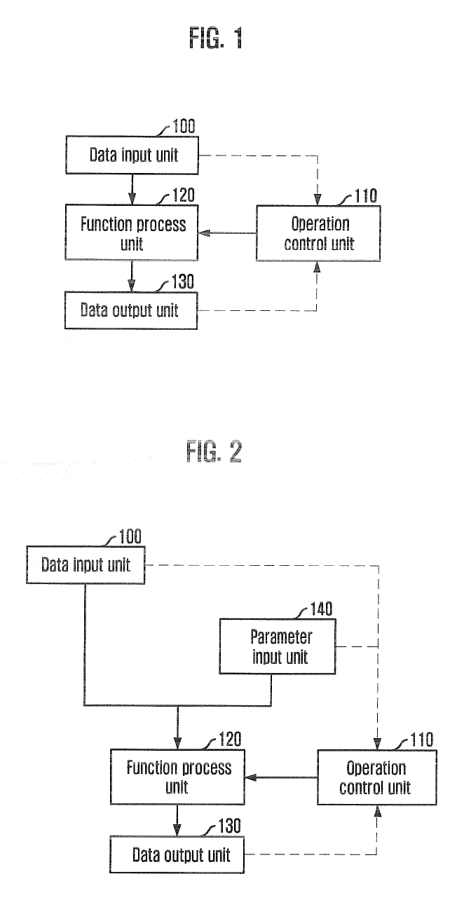

FIG. 2 is a block diagram describing a functional module in accordance with another embodiment of the present invention.

The functional module shown in FIG. 2 further includes a parameter input unit 140 when compared with the functional module shown in FIG. 1. The parameter input unit 140 receives parameter information for controlling the operation of the function process unit. The parameter input unit 140 includes a general memory and a memory control logic.

The function process unit 120 can process functions of different modes according to the inputted parameters. The operation control unit 110 determines whether to operate the function process unit 120 by checking the input state of the parameter. That is, the operation control unit 110 transmits a control signal for starting operation of the function process unit 120 to the function process unit 120 when data are stored in the data input unit 100 and the parameter input unit 140 and a space for storing data is enough in the data output unit or when data output is completed.

The operation control unit 110 will be described in detail hereinafter. The operation of the operation control unit 110 can be realized differently according to configuration of the data input unit 100 or the data output unit 130. Following examples are conventional cases but the present invention is not limited to the examples.

The operation control unit 110 checks a data input state signal received from the data input unit 100 and a data output state signal received from the data output unit 130 after being transferred from an initial reset state to an idle state. The operation control unit 110 generates a control signal for starting the operation of the function process unit 120 when the data input state signal indicates 1 showing that data input is completed and the data output state signal indicates 1 showing that data output is completed and data can be stored.

Meanwhile, when the operation control unit 110 controls the data output unit 130, the operation control unit 110 receives from the function process unit 120 a signal that the operation is completed, receives from another functional module a signal that data can be inputted, and generates a control signal driving the data output unit 130.

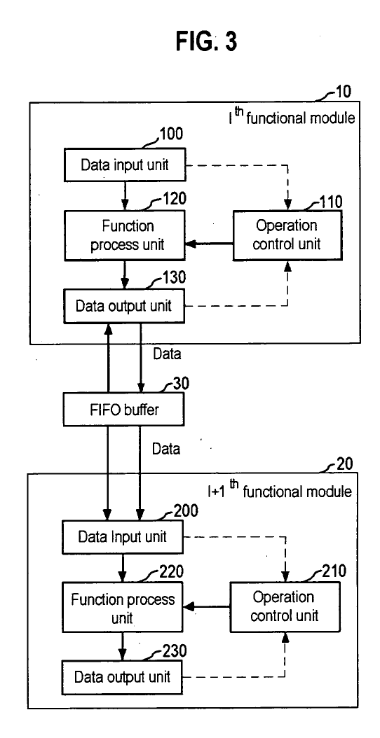

FIG. 3 is a block diagram showing a system using a plurality of functional modules in accordance with an embodiment of the present invention. FIG. 3 shows an example of a functional module connection structure having an individual first-in first-out (FIFO) buffer 30 for data transmission between the functional modules.

Referring to FIG. 3, the system uses an i^{th} functional module 10 and an i+1^{th} functional module 20. The i^{th} functional module 10 includes the data input unit 100, the operation control unit 110, the function process unit 120 and the data output unit 130. The i+1^{th} functional module 20 includes a data input unit 200, a data output unit 230, a function process unit 220 and an operation control unit 210.

The data output unit 130 of the i^{th} functional module 10, where i is a certain natural number, transmits stored data to the FIFO buffer 30. The data input unit 200 of the i+1^{th} functional module 20 cooperating with the i^{th} functional module 10, where i+1^{th} is a certain natural number, receives data from the FIFO buffer 30. That is, when the FIFO buffer 30 is not full, i.e., when a FIFO_Full signal is 0, the data output unit 130 of the i^{th} functional module outputs the stored data to the FIFO buffer 30. When there are data in the FIFO buffer 30, i.e., when a FIFO_Empty signal is 0, the data input unit 200 of the i+1^{th} functional module reads data from the FIFO buffer 30.

When a transmission quantity of the parameters is large, the parameter transmission can be performed by using the FIFO buffer between the functional modules, in the same form as the data transmission. When the i^{th} functional module cooperates with the i+1^{th} functional module, the data input unit of the i+1^{th} functional module performs the function of the data output unit, and the data output unit of the i^{th} functional module can perform the function of the data input unit.

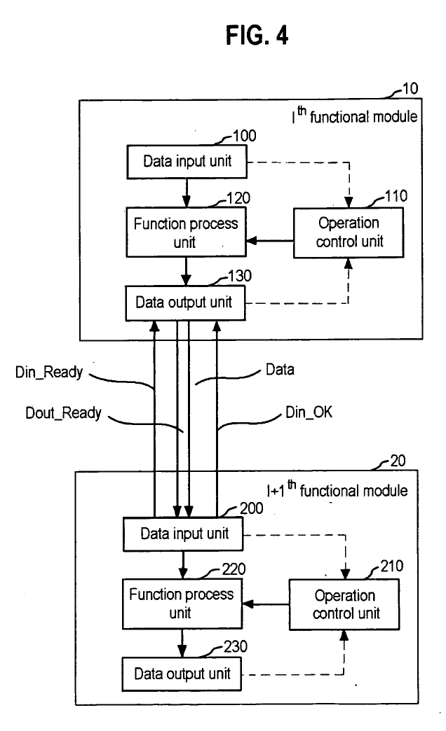

FIG. 4 is a block diagram showing a system using a plurality of functional modules in accordance with another embodiment of the present invention. FIG. 4 shows an example of a module connection structure having a format that the functional modules directly transmit data without using an individual buffer for data transmission between two functional modules.

When the data input unit 200 of the i+1^{th} functional module completes an internal operation and prepares to receive new data, the data input unit 200 of the i+1^{th} functional module generates a data input preparation signal Din_Ready and transmits the Din_Ready to the data output unit 130 of the i^{th} functional module. When the data output unit 130 of the i^{th} functional module prepares to output data, the data output unit 130 of the i^{th} functional module generates a data output preparation signal Dout_Ready, transmits the Dout_Ready to the data input unit 200 of the i+1^{th} functional module, and notifies that preparation for data transmission is completed.

Accordingly, a necessary quantity of data is transmitted to the data input unit 200 of the i+1^{th} functional module in the data output unit 130 of the i^{th} functional module. When the data are completely transmitted, the data input unit 200 of the i+1^{th} functional module generates a data input completion signal Din_OK and notifies to the data output unit 130 of the i^{th} functional module that the data transmission is completed. The parameter transmission may be performed in the form of data transmission.

As described above, since the present invention performs self-control without control by the control processor of each functional module, the present invention can control operation more quickly than the system that the control processor controls each functional module, thereby improving process performance.

While the present invention has been described with respect to the specific embodiments, it will be apparent to those skilled in the art that various changes and modifications may be made without departing from the spirit and scope of the invention as defined in the following claims.

What is claimed is:

1. A functional module used in a system including a plurality of functional modules for performing independent functions, comprising:
a data input means for receiving data;
a function process means for performing a specific function based on input data transmitted through the data input means;
a data output means for outputting a result processed by the function process means; and
an operation control means for receiving state information individually from the data input means and the data output means and controlling operation start of the function process means based on state information of the data input means and the data output means.

2. The functional module of claim 1, further comprising:
a parameter input means for receiving a parameter for determining an operation mode of the function process means,
where the operation control means controls operation start of the function process means based on state information of the data input means, the data output means and the parameter input means.

3. The functional module of claim 1, wherein the operation control means outputs a control signal which indicates the operation start of the function process means in cases that the state information of the data input means shows presence of inputted data and that the state information of the data output means shows presence of the storing space.

4. The functional module of claim 2, wherein the operation control means outputs a control signal which indicates the operation start of the function process means in cases that the state information of the data input means shows presence of inputted data, that the state information of the data output means shows presence of the storing space, and that the state information of the parameter input means shows presence of inputted parameters.

5. The functional module of claim 1, wherein each of the data input means and the data output means includes a memory and a memory control logic.

6. A functional module used in a system including a plurality of functional modules for performing independent functions, comprising:
a first data input means for receiving data;
a first function process means for performing a specific function based on input data transmitted through the first data input means;
a first data output means for outputting a result processed by the first function process means; and
an operation control means for receiving state information from the first data input means, receiving state information of a second data input means and information of a second function process means included in another cooperating functional module from another cooperating functional module, and controlling operation start of the first function process means based on the state information of the first and second data input means.

7. The functional module of claim 6, further comprising:
a parameter input means for receiving a parameter for determining an operation mode of the first function process means,
where the operation control means controls operation start of the first function process means based on state information of the first and second data input means, and the parameter input means.

8. The functional module of claim 6, wherein the operation control means outputs a control signal which indicates operation start of the first function process means in cases that the state information of the first data input means shows presence of inputted data and that the state information of the second data input means shows presence of space for receiving data.

9. The functional module of claim 7, wherein the operation control means outputs a control signal which indicates operation start of the first function process means in cases that the state information of the first data input means shows presence of inputted data, that the state information of the second data input means shows presence of space for receiving data and that the state information of the parameter input means shows presence of inputted parameters.

10. A method for controlling operation in a functional module used in a system including a plurality of functional modules for performing independent functions, comprising the steps of:
receiving input data state information showing whether there are input data and output data state information showing whether processed data can be stored; and
outputting a control signal which indicates operation start of a function process means for performing an independent function in cases that the input data state information shows presence of inputted data and that the output data state information shows presence of the storing space.

11. The method of claim 10, further comprising the step of:
receiving a parameter for determining an operation mode of the function process means,
where in the step of outputting the control signal, the control signal indicating the operation start of the function process means performing the independent function in cases that the input data state information shows presence of inputted data and that the output data state information shows presence of storing space and presence of the inputted parameter is outputted.

12. A system comprising a plurality of functional modules for performing independent functions, each functional module comprising:
a data input means for receiving data;
a function process means for performing a specific function based on input data transmitted through the data input means;
a data output means for outputting a result processed by the function process means; and
an operation control means for receiving state information individually from the data input means and the data output means and controlling operation start of the function process means based on the state information of the data input means and the data output means,
where the data output means of a first functional module and the data input means of a second functional module cooperatively transmit and receive a control signal and data are directly transmitted from the data output means of the first functional module to the data input means of the second functional module.

13. The system of claim 12, wherein the data input means of the second functional module transmits a data input preparation signal to the data output means of the first functional module, receives a data output preparation signal and data from the data output means of the first functional module as a response, and notifies completion of data transmission to the data output means of the first functional module when the data transmission is completed.

14. The system of claim 13, each functional module further comprising:
a parameter input means for receiving a parameter for determining an operation mode of the function process means,
where the operation control means controls operation start of the function process means based on state information of the data input means, the data output means and the parameter input means.
